(19) United States
(12) Patent Application Publication
(10) Pub. No.: US 2026/0038235 A1
(43) Pub. Date: Feb. 5, 2026

(54) DIGITAL IMAGE VISUAL SIMILARITY DETERMINATION

(71) Applicant: Adobe Inc., San Jose, CA (US)

(72) Inventors: Simon Jenni, Hagendorf (CH); John Philip Collomosse, Pyrford (GB); Jamie Delbick, San Francisco, CA (US); Hyman Chung, San Ramon, CA (US); Clinton Hansen Goudie-Nice, Salt Lake City, UT (US); Alexander Klimetschek, San Francisco, CA (US)

(73) Assignee: Adobe Inc., San Jose, CA (US)

(21) Appl. No.: 18/791,843

(22) Filed: Aug. 1, 2024

(51) Int. Cl. G06V 10/74; G06V 10/44; G06V 10/771; G06V 10/82

(52) U.S. Cl. CPC G06V 10/761; G06V 10/44; G06V 10/771; G06V 10/82

(57) ABSTRACT

Digital image visual similarity determination techniques are described. In implementations, a search result is generated based on visual similarity of a plurality of digital images with respect to an input digital image. The search result is generated by locating a plurality of candidate digital images from the plurality of digital images based on a search, calculating spatial feature maps for the input digital image and the plurality of candidate digital images using respective layers of one or more neural networks, and forming a plurality of similarity scores by comparing the spatial feature maps from the plurality of candidate digital images, respectively, with the spatial feature maps for the input digital image.

### BACKGROUND

Visual similarity of digital images is used as a basis to support a variety of different asset management functionalities as implemented by computing devices. An example of which includes a digital image search. However, conventional digital image search techniques are confronted with numerous technical challenges in determining visual similarity due to differences in the digital images that can causes these techniques to fail in particular scenarios.

Conventional digital image similarity techniques, for instance, are sensitive to a variety of differences, such as cropping, localized edits, resizing, compression, format changes, and so forth. Consequently, these sensitivities affect what digital images are and are not considered visually similar by conventional digital image similarity systems. Therefore, these conventional techniques may function for a particular scenario yet fail when used in other scenarios.

### SUMMARY

Digital image visual similarity determination techniques are described. In one or more examples, these techniques are usable to locate digital images that are visually similar within a threshold amount, e.g., differ solely through inclusion of low-level artifacts. To do so, a visual similarity system employs a machine-learning model to locate candidate digital images based on encodings of the digital images. The candidate digital images are then processed using layers of a machine-learning model (e.g., a convolutional neural network) to generate spatial features maps that are usable as intermediate neural activation levels to generate a similarity score to quantify an amount of visual similarity between respective digital images, e.g., an input digital image and the candidate digital images.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ digital image visual similarity determination techniques as described herein.

FIG. 2 depicts a system in an example implementation showing operation of a visual similarity system of FIG. 1 in greater detail.

FIG. 3 depicts a system showing operation of a candidate search module of FIG. 2 in greater detail.

FIG. 4 depicts a system in an example implementation showing operation of a similarity determination module of FIG. 2 in greater detail as calculating similarity scores.

FIG. 5 depicts a system in an example implementation showing operation of first and second machine-learning models of the similarity determination module of FIG. 4 in greater detail.

FIG. 6 is a flow diagram depicting an algorithm as a step-by-step procedure in an example implementation of operations performable for accomplishing a result of a digital image visual similarity determination.

FIG. 7 is a flow diagram depicting an algorithm as a step-by-step procedure in an example implementation of operations performable for accomplishing a result of visual asset management involving grouping of visually similar assets.

FIG. 8 illustrates an example system including various components of an example device that can be implemented as any type of computing device as described and/or utilize with reference to the previous figures to implement embodiments of the techniques described herein.

### DETAILED DESCRIPTION

### Overview

Visual similarity of digital images is used as a basis to support a variety of different functionalities as implemented by computing devices. Conventional digital image similarity techniques, however, are sensitive to a variety of differences in the digital images. Consequently, these sensitivities affect what digital images are and are not considered visually similar by respective conventional digital image similarity systems and therefore may fail in some scenarios.

Some conventional digital image similarity techniques, for instance, are configured to be resistant to cropping and other image augmentations, an example of which is referred to as content authenticity initiative fingerprinting. Other digital image similarity techniques that rely on image hashing, on the other hand, are sensitive to resizing, compression, and format changes. Consequently, these conventional techniques may fail in scenarios tasked with locating digital images that differ solely in low-level processing artifacts, e.g., in locating duplicates.

Accordingly, digital image visual similarity determination techniques are described that support visual similarity determinations that are not possible in conventional techniques. These techniques, for instance, support location of digital images as part of search that differ solely in low-level processing artifacts, e.g., resizing, compression, or file-format conversion of images. These techniques are also suitable to identify differences in localized edits due to cropping (e.g., to fit different types of display devices), changes in displayed texted (e.g., for multilingual contexts), visually noticeable adjustments in color, contrast, and brightness, and so on. As such, these techniques may be employed in a variety of visual similarity determination scenarios that would fail using conventional techniques, e.g., to locate visually “identical” digital images differing solely in low-level artifacts, form duplicate groupings for asset management, and so forth.

To do so, a visual similarity system is configurable in a variety of ways. In one or more examples, the visual similarity system supports large scale retrieval of candidate digital images from a dataset, e.g., using a learned asset embedding that is implemented using machine learning. The visual similarity system also employs a highly discriminative image similarity computation to compute similarity scores by comparing the candidate digital images at multiple intermediate levels of neural network activations.

In this way, the visual similarity system functions as a scalable system for ingestion and processing of a large set of digital images (e.g., visual assets) to extract asset identities. The extracted asset identities permit automatic discovery and organization of the digital images into groups of “identical” assets, i.e., assets that have at least a threshold amount of similarity based on the similarity scores. As a result, the visual similarity system improves visual asset management, including an ability to maintain and choose from each of the visual assets associated with a campaign or product. Further discussion of these and other examples is included in the following sections and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Digital Image Visual Similarity Determination Environment

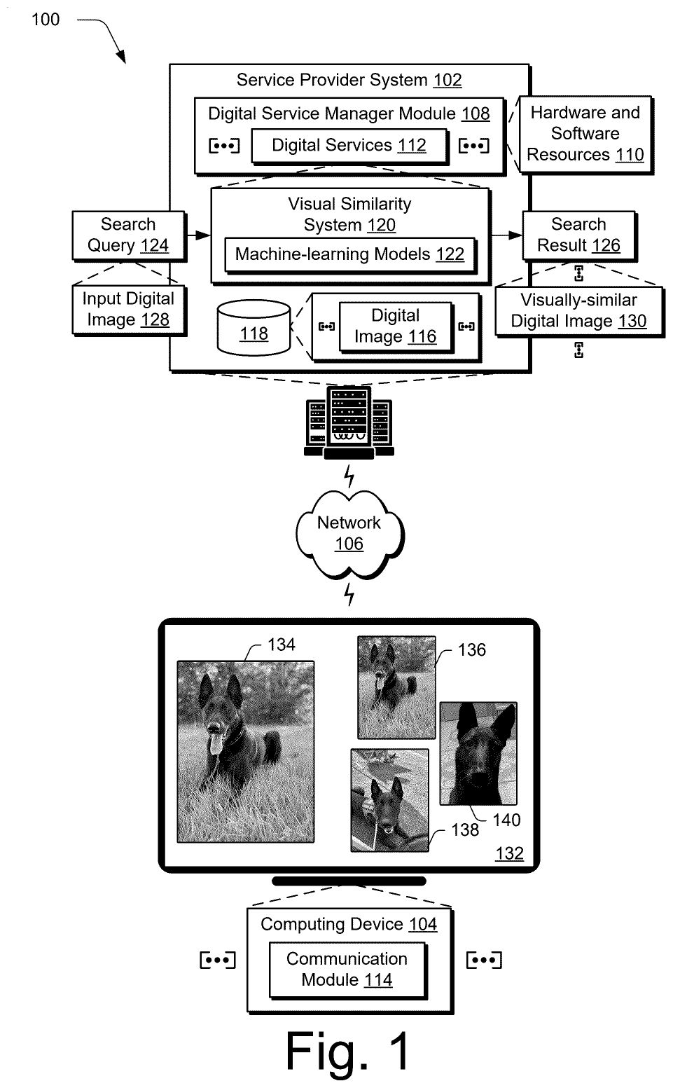

FIG. 1 is an illustration of a digital medium environment 100 in an example implementation that is operable to employ digital image visual similarity determination techniques as described herein. The illustrated environment 100 includes a service provider system 102 and a computing device 104 that are communicatively coupled, one to another, via a network 106. Computing devices are configurable in a variety of ways.

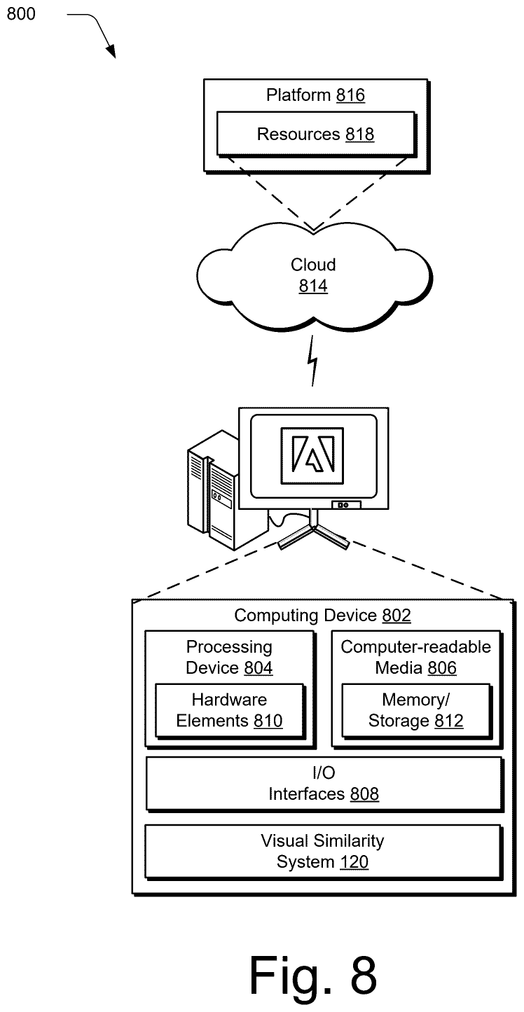

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 8.

The service provider system 102 includes a digital service manager module 108 that is implemented using hardware and software resources 110 (e.g., a processing device and computer-readable storage medium) in support of one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

The service provider system 102 is also configured in this example to manage a repository of digital images 116, which are illustrated as maintained locally in a storage device 118 but may also be implemented remotely via a network 106. The digital images 116 are configurable in a variety of ways, examples of which include digital documents, slides of a presentation, raster images, vector images, bitmaps, webpages, frames of a digital video, and so forth. As such, the digital images 116 are configurable in support of a variety of functionality, including use as visual assets as part of marketing campaigns and branding.

In the illustrated example, the digital services 112 are utilized to implement a visual similarity system 120. The visual similarity system 120 is implemented using one or more machine-learning models 122 to process a search query 124 to generate a search result 126. The search result 126 is generated by locating one or more digital images 116 that are visually similar based on an input digital image 128 included in the search query 124. An example of which is illustrated as a visually similar digital image 130 in the search result 126.

As previously described, visual similarity is utilized to implement a variety of search functionalities for use in a variety of scenarios. However, what it means to be “visually similar” may differ between scenarios. Some conventional digital image similarity techniques, for instance, are configured to be resistant to cropping and other image augmentations, an example of which is referred to as content authenticity initiative fingerprinting. Other digital image similarity techniques that rely on image hashing, on the other hand, are sensitive to resizing, compression, and format changes. Consequently, these conventional techniques may fail in scenarios tasked with locating digital images that differ solely in low-level processing artifacts that are considered “visually identical,” e.g., for use in locating duplicates, grouping duplicate visual assets, and so forth.

Accordingly, the visual similarity system 120 supports techniques to identify groups of “visually identical” digital images 116 in potentially large-scale datasets. To do so, the visual similarity system 120 is configurable to implement a retrieval approach to find candidate duplicates using robust visual descriptors and efficient nearest-neighbor search using the one or more machine-learning models 122. The visual similarity system 120 is also configurable to employ the one or more machine-learning models 122 to generate a similarity score using a similarity computation based on a neural network model that compares images at multiple intermediate activation layers of a neural network.

In the illustrated user interface 132, for instance, an example 134 of an input digital image 128 is usable to search a first example 136, a second example 138, and a third example 140 of digital images 116 from an asset dataset. The visual similarity system 120 in this example is configurable to determine that an example 136 the search result 126 is a visually similar digital image 130 as a duplicate of the example 134 of the input digital image 128. The visual similarity system 120 is also configurable to distinguish from the second example 138 including a different image of the same dog captured in the input digital image 128 and a third example 140 of a same type of dog but is a different dog.

Thus, the visual similarity system 120 is configurable to address subtle localized edits due to cropping, changes in displayed texts and visually noticeable adjustments in color, contrast, brightness, and so on. The visual similarity system 102 is further configurable to consider digital images as “visually identical” when limited to differences caused by low-level processing artifacts resulting from resizing, compression, file-format conversions, and so forth, which is not possible in conventional techniques.

As a result, the visual similarity system 120 functions as a scalable system for ingestion and processing of a large set of digital images (e.g., visual assets) to extract asset identities. The extracted asset identities are used as a basis to automatically discover and organize the digital images into groups of “identical” assets, i.e., assets that have at least a threshold amount of similarity based on the similarity scores. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Digital Image Visual Similarity Determination

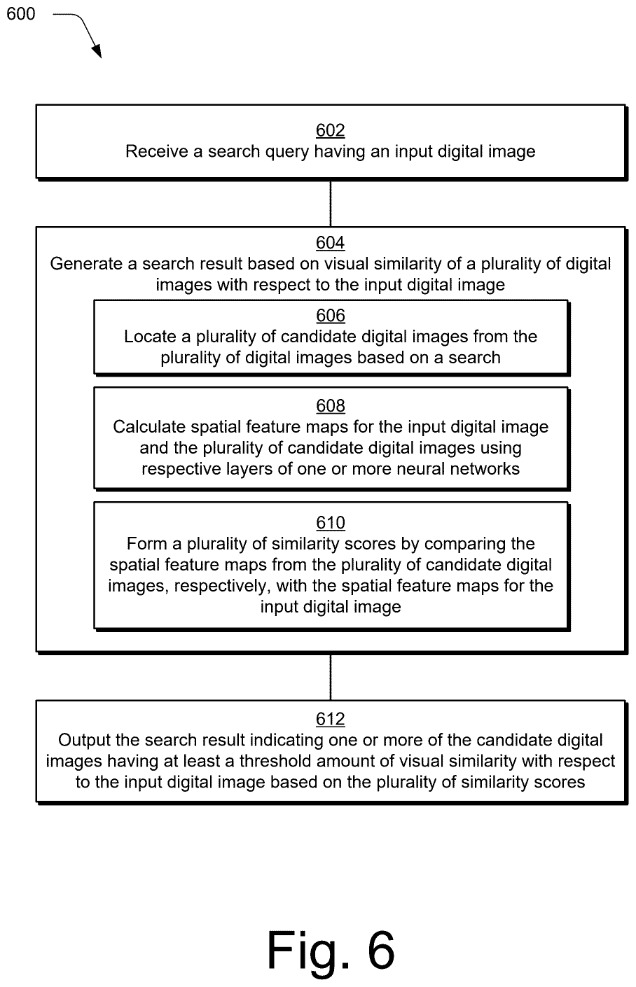

The following discussion describes visual similarity determination techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 6 is a flow diagram depicting an algorithm 600 as a step-by-step procedure in an example implementation of operations performable for accomplishing a result of a digital image visual similarity determination. In portions of the following discussion, reference will be made in parallel to the algorithm 600 of FIG. 6.

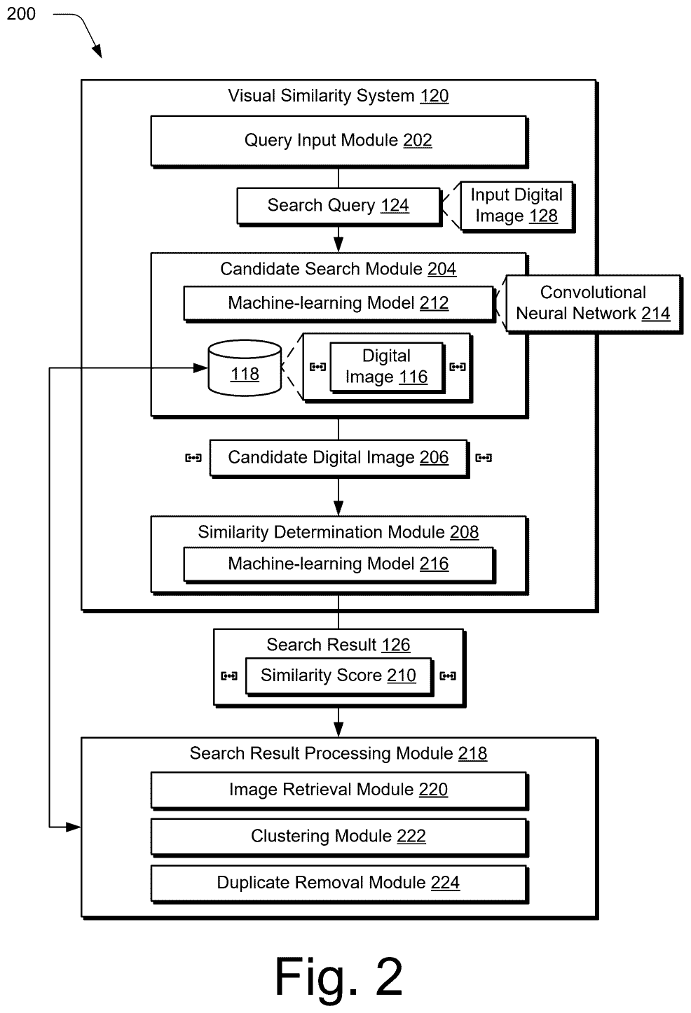

FIG. 2 depicts a system 200 in an example implementation showing operation of the visual similarity system 120 of FIG. 1 in greater detail. To begin in this example, a query input module 202 receives a search query 124, which in this instance includes an input digital image 128 (block 602). The search query 124, for instance, is receivable via user interaction with a user interface 132, received over the network 106 from one or more computing devices, selected from the digital images 116, and so forth.

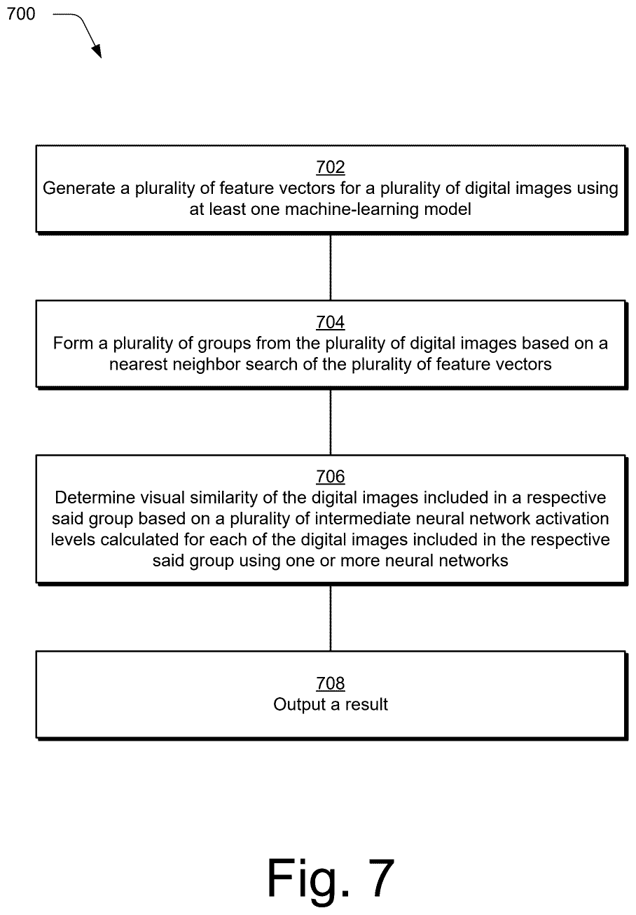

The search query 124 is configurable to locate other digital images from an asset repository that are considered “duplicates” and as such differ solely through inclusion of low-level processing artifacts, e.g., resizing, compression, file-format conversion of images, and so forth. Other examples are also contemplated, including asset management through asset grouping as further described in relation to FIG. 7.

A search result 126 is then generated by the visual similarity system 120 based on visual similarity of a plurality of digital images 116 with respect to the input digital image 128 (block 604) of the search query 124. To improve operational and computation resource consumption efficiency, a two-step search process is utilized by the visual similarity system 120 in this example to generate the search result 126.

First, a candidate search module 204 is employed to locate a plurality of candidate digital images 206 from the plurality of digital images based on a search (block 606). Second, a similarity determination module 208 is then utilized to calculate spatial feature maps for the input digital image 128 and the plurality of candidate digital images 206 using respective layers of one or more neural networks (block 608). In this way, the candidate search module 204 locates potentially visually similar candidate digital images first in an efficient manner and then processes those candidates in a robust manner to determine visual similarity.

The candidate search module 204, for instance, is configurable to generate feature vectors of the digital images 116 using one or more machine-learning models 212, e.g., a convolutional neural network 214. To do so, the candidate search module 204 employs nearest-neighbor retrieval in an embedding space of the convolutional neural network 214 to find the plurality of candidate digital images 206 from the digital images 116 in a dataset. This allows, for instance, the visual similarity system 120 to perform large-scale retrieval of a set of “top-k” candidate digital images 206 for each of the digital images 116 in the dataset, for a single input digital image 128 included in a search query 124, and so forth.

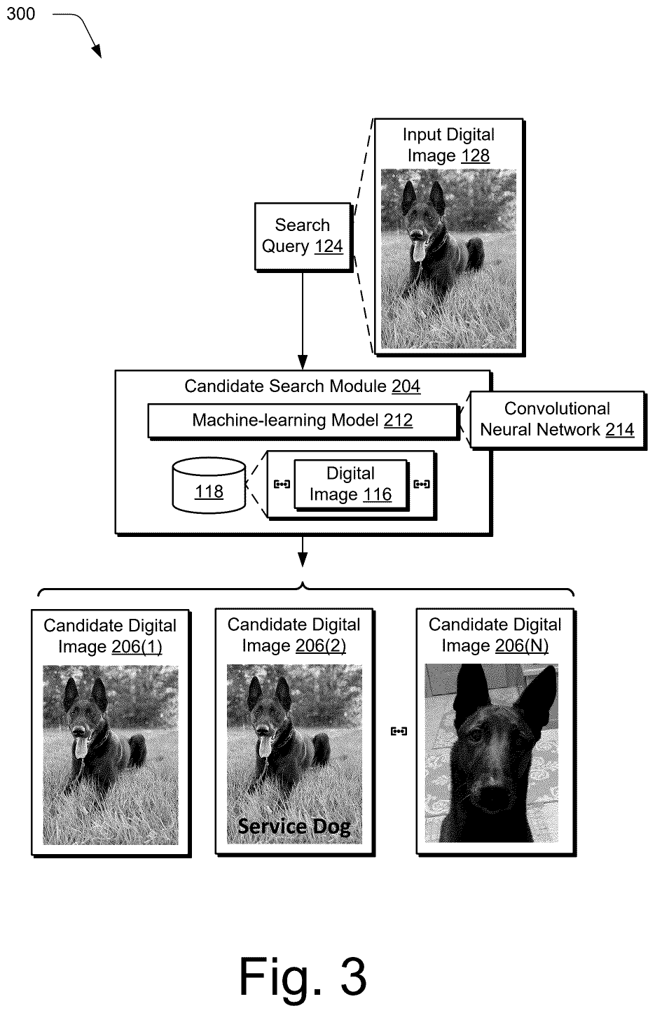

FIG. 3 depicts a system 300 showing operation of the candidate search module 204 of FIG. 2 in greater detail. In this example, the search query 124 is illustrated as received externally, e.g., via a user interface. Other examples are also contemplated, in which, the input digital image 128 of the search query 124 is selected from the digital images 116 included in the storage device 118, e.g., to perform asset management as further described in relation to FIG. 7.

The one or more machine-learning models 212 of the candidate search module 204 in this example are configured to learn an embedding model “ϕᵢ=E(xᵢ)∈R^{d}” for image inputs “xᵢ∈R^{224×224×3}” using a CNN image encoder “E,” which encodes images in a d-dimensional vector space. In one or more examples, the image encoder “E” is implemented using a ResNet-50 architecture and a Multi-Layer-Perceptron (MLP) to project encodings into a “d=256-dimensional” embedding space.

The CNN image encoder “E” is trainable in a variety of ways. In one or more examples, the CNN image encoder “E” is trained through a contrastive learning objective as follows:

$${ℒ}_{C} = - {\sum }_{i ∈ ℬ} log ( \frac{d ( {ϕ}_{i} , {\hat{ϕ}}_{i} )}{d ( {ϕ}_{i} , {\hat{ϕ}}_{i} ) + {\sum }_{j \neq i ∈ ℬ} d ( {ϕ}_{i} , {ϕ}_{k} )} ) , \qquad ( 1 )$$

where “\hat{ϕ}ᵢ” represents an embedding of a differently augmented version of “xᵢ” and:

$$d ( a , b ) := exp ( \frac{1}{λ} \frac{{a}^{T} b}{{‖ a ‖}_{2} {‖ b ‖}_{2}} )$$

measures a similarity between the feature vectors “a” and “b,” with “B” representing a randomly sampled training mini batch. In an implementation, a strong data augmentation technique is utilized for contrastive learning, which includes random cropping, color jittering, blurring, resizing, and so forth. This data augmentation technique produces image representations that are robust to input corruptions and thus benefit the retrieval of visually similar assets from a dataset.

Given a dataset “D={x₁, . . . , x_{N}}” of “N” images, each digital image is encoded with the robust embedding model “E” to obtain a set of descriptors “{ϕ₁, . . . , ϕ_{N}},” i.e., feature vectors. Given an input digital image 128 “x_{q}”, a set of candidate digital images 206 “NNₖ(x_{q})” is located as a set of “k” nearest neighbors to “x_{q}” in “D.” Cosine distance is used in the following example by the candidate search module 204 to compute the nearest neighbors as follows:

$$d ( {x}_{q} , {x}_{i} ) = 1 - \frac{{{x}_{q}}^{T} {x}_{i}}{‖ {x}_{q} ‖ ‖ {x}_{i} ‖} , \qquad ( 2 )$$

as a distance measure between the query “x_{q}” and each example “xᵢ” in the dataset, e.g., the digital images 116. The candidate search module 204 then outputs the set of candidate digital images 206 of a “k” number of digital images that have at least a threshold amount of similarity. In other words, the k candidates with the highest similarity. In the illustrated example, an input digital image 128 is used to locate candidate digital image 206(1), candidate digital image 206(2), through candidate digital image 206(N). The plurality of candidate digital images 206(1)-206(N) are then passed as an input to a similarity determination module 208.

Returning again to FIG. 2, the similarity determination module 208 is utilized to calculate spatial feature maps for the input digital image 128 and the plurality of candidate digital images 206 using respective layers of one or more neural networks (block 608) of a machine-learning model 216. The spatial feature map, for instance, is configurable as a matrix of values that capture visual features of a respective digital image, e.g., edges, textures, patterns, and so forth.

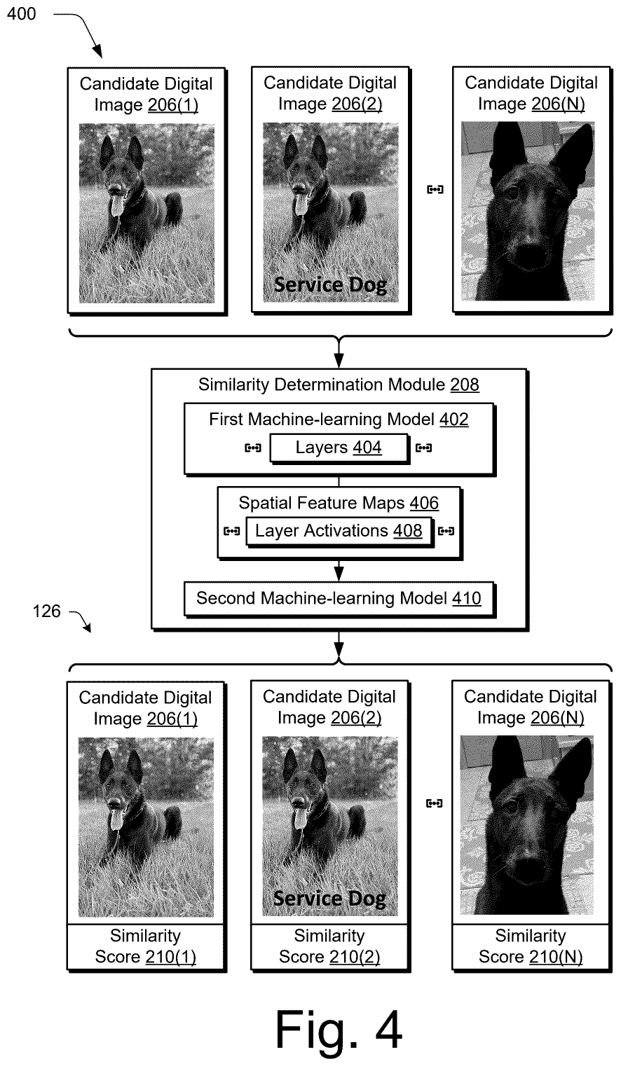

FIG. 4 depicts a system 400 in an example implementation showing operation of the similarity determination module 208 of FIG. 2 in greater detail as calculating similarity scores. The similarity determination module 208 includes a first machine-learning model 402 having a plurality of layers 404, e.g., implemented using a convolutional neural network (CNN). The first machine-learning model 402 is configured to generate spatial feature maps 406, e.g., to highlight areas of a digital image that contain horizontal lines or specific shapes. Each filter in a CNN is configurable to detect a different type of visual feature, and so a single digital image as processed by the CNN may produce multiple feature maps, one for each filter applied. As a digital image progresses through layers 404 of the CNN, these feature maps become increasingly abstract, representing more complex features.

A second machine-learning model 410 is then configured to form a plurality of similarity scores 210(1), 210(2), . . . , 210(N) for respective candidate digital images 206(1), 206(2), . . . , 206(N). The plurality of similarity scores 210(1), 210(2), . . . , 210(N) are formed by comparing the spatial feature maps from the plurality of candidate digital images, respectively, with the spatial feature maps for the input digital image (block 610).

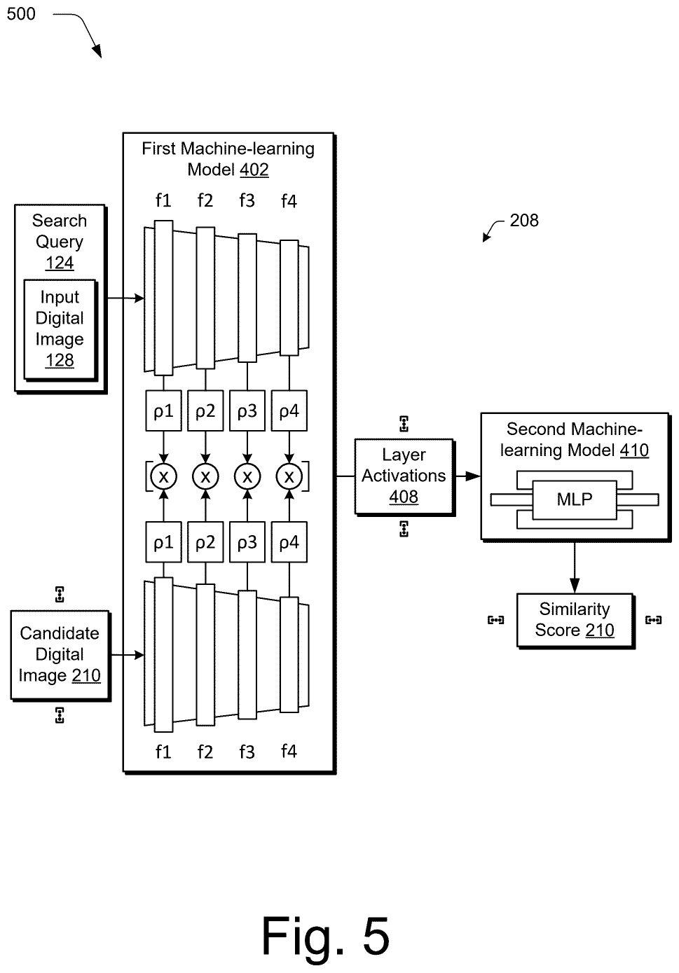

FIG. 5 depicts a system 500 in an example implementation showing operation of the first and second machine-learning models of the similarity determination module of FIG. 4 in greater detail. In this example, instead of comparing the aggregated feature vectors as performed in the first stage, the first and second machine-learning models 402, 410 are implemented to compare layer activations 408 at a level of spatial feature maps extracted at multiple intermediate layers of a CNN. By operating on features at different levels of the CNN, the similarity determination module 208 has access to image differences at different levels of abstraction, e.g.,, earlier layers represent low-level features, whereas deeper layers have higher-level semantic content.

For example, let “fₗ^{q}∈ [symbol] ^{H}^{ₗ}^{×W}^{ₗ}^{×D}^{ₗ}”, represent a feature map for a query image “x_{q}” extracted at layer “l” of a feature extraction network “F” which may be shared for the two stages, i.e., “F=E.” Let “{fₗⁱ}i^{k}=1” represent “k” corresponding retrieval feature maps at layer “l.” At each layer, the two feature maps are processed with learned layers “ρₗ,” as a linear projection followed by “l₂” normalization, e.g., along a channel dimension. Layer-wise feature similarities are then computed by the similarity determination module 208 between a query “x_{q}” and candidate “xᵢ” as:

$${s}^{q i} l = Flatten ( \frac{{ρ}_{l} ( {f}_{l}^{q} ) ⊙ {ρ}_{l} ( f {}_{l}^{i} )}{λ} ) ∈ {{H}_{ι} {W}_{ι}}^{} , \qquad ( 3 )$$

where “⊙” denotes a dot-product applied over the channel dimension and “λ32 0.2” is a temperature parameter. Each of the flattened layer-wise similarities are then collected into a single vector via concatenation as follows:

$${s}_{q i} = [ {s}^{q i} 1 , … , {s}^{qi} L ] ∈ {R}^{d} , \qquad ( 4 )$$

where a final similarity vector's dimension is given by:

$$d = {\sum }_{l} {H}_{l} {W}_{l}$$

The aggregated similarity features “S_{qi}” are fed to a three-layer multilayer perceptron (MLP) as illustrated for the second machine-learning model 410, which outputs a similarity score 210 quantifying a comparison between query digital image “q” and candidate digital image “i.” For example, the similarity score between image “x_{q}” and “xᵢ” is definable as:

$$score ( {x}_{q} , {x}_{i} ) = σ MLP ( {s}^{qi} ) ) , \qquad ( 5 )$$

where “σ” represents a sigmoid activation.

The first and second machine-learning models 402, 410 are trained, in one or more examples, as a binary classifier with two classes of image pairs as input. The image pairs include pairs of “identical” assets (e.g., up to a pre-defined set of image transformations) and pairs of “non-identical” assets, e.g., obtained through identity-non-preserving transformations. To promote strict image similarity (i.e., matching images that differ solely in low-level pixel artifacts arising from resizing, compression, or encoding), an augmentation technique is employed for training the similarity model.

To build positive example pairs, random combinations of identity-preserving transformations are leveraged. In a first example, random resizing is performed in which both the target size and interpolation algorithm are randomized. A target size, for instance, is chosen independently for height and width and with a random resize factor. The training digital images are also generated using randomly chosen compression rates, e.g., sampling JPEG quality from a range. Encoding conversions are also employed to re-encode the training digital images in a different format, e.g., JPEG, PNG, or WebP.

To generate negative examples for training, the identity-preserving transformations are combinable with a variety of identity-non-preserving transformations. Examples of which include randomized cropping in which a crop is randomly selected with an area covering between fifty to one hundred percent of a training digital image. Randomized rotations are also chosen, e.g., in a range of between minus twenty and positive twenty degrees. Color jittering is also supported to randomize brightness, contrast and hue. A random patch (or segment) of a training digital image may also be replaced with a patch from another image to simulate localized edits to produce a negative training sample.

Given pairs of true and false matches, the machine-learning models are trained with a binary cross-entropy loss using mini-batch stochastic gradient descent. During similarity model training, a backbone feature extractor may be “frozen” to limit training to the new and randomly initialized parameters in the projection layers “ρl” of the first machine-learning model 402 and a final MLP classifier of the second machine-learning model 410.

Returning again to FIG. 2, a search result 126 is output by the similarity determination module 208. The search result 126, for instance, is configured for display in a user interface as indicating one or more of the candidate digital images having at least a threshold amount of visual similarity with respect to the input digital image based on the plurality of similarity scores 210 (block 612). A variety of other examples are also contemplated.

A search result processing module 218 is illustrated as representative of a variety of functionalities usable leverage the search result 126 and similarity score 210. An image retrieval module 220, for instance, is usable as described in relation to FIGS. 2-4 to locate a visually similar digital image. The visual similarity system 120, for instance, is configurable to determine that a candidate digital image 206(1) has a similarity score 210(1) within a defined threshold “Tmatch” with respect to the input digital image 128 of a search query 124. A candidate digital image 206(2) that includes the same digital image but with text does not and is not included in this example.

A clustering module 222 is representative of batch ingestion and grouping functionality, e.g., that is usable to implement large-scale ingestion and processing of a dataset to uncover sets of identical assets. To achieve this, visual assets may be embedded into a vector database using the embedding model of the one or more machine-learning models 212 of the candidate search module 204 as previously described. Candidate matches are then processed for each asset using the similarity determination module 208. In an implementation, similarity scores are computed already during ingestion as the search index is being built to support parallelization of the two processes and presentation of the newly ingested data on the fly.

A duplicate removal module 224 is representative of functionality to filter the digital images 116 based on embedding similarity. While computing the exact similarity model over a larger set of candidate pairs will improve the system's recall, this step also has a significant negative effect on overall performance. To improve performance, candidate pairs of digital images may be filtered based on embedding similarity from the first stage. Two thresholds, for instance, may be chosen such as “τ_{low}” for pairs showing “d(x, y)<τ_{low}” and are assigned “score(x,y)=1” automatically, thus skipping operation of the similarity determination module 208 in those instances. Likewise, a threshold “Thigh” may be chosen to set “score(x,y)=0” whenever “d(x,y)>τ_{high}” for digital images that are significantly visually dissimilar.

FIG. 7 is a flow diagram depicting an algorithm 700 as a step-by-step procedure in an example implementation of operations performable for accomplishing a result of a visual asset management involving grouping of visually similar assets. To begin in this example, a plurality of feature vectors are generated for a plurality of digital images using at least one machine-learning model (block 702), e.g., using a convolutional neural network 214 of the one or more machine-learning models 212 of the candidate search module 204. A plurality of groups are formed from the plurality of digital images based on a nearest neighbor search of the plurality of feature vectors (block 704), e.g., based on Cosine similarity. Visual similarity of the digital images included in a respective group is determined based on a plurality of intermediate neural network activation levels calculated for each of the digital images included in the respective said group using one or more neural networks (block 706), e.g., by the machine-learning model 216 of the similarity determination module 208. A result of the determination is then output (block 708), which may include automated identification of digital images considered duplicates in a dataset.

As described above, the digital image visual similarity determination techniques support visual similarity determinations that are not possible in conventional techniques. These techniques, for instance, support location of digital images as part of search that differ solely in low-level processing artifacts, e.g., resizing, compression, or file-format conversion of images. These techniques are also suitable to identify differences in localized edits due to cropping (e.g., to fit different types of display devices), changes in displayed texted (e.g., for multilingual contexts), visually noticeable adjustments in color, contrast, and brightness, and so on. As such, these techniques may be employed in a variety of visual similarity determination scenarios that would fail using conventional techniques, e.g., to local visually “identical” digital images differing solely in low- level artifacts, form duplicate groupings for asset management, and so forth.

### Example System and Device

FIG. 8 illustrates an example system generally at 800 that includes an example computing device 802 that is representative of one or more computing systems and/or devices that implement the various techniques described herein. This is illustrated through inclusion of the visual similarity system 120. The computing device 802 is configurable, for example, as a server of a service provider, a device associated with a client (e.g., a client device), an on-chip system, and/or any other suitable computing device or computing system.

The example computing device 802 as illustrated includes a processing device 804, one or more computer-readable media 806, and one or more I/O interface 808 that are communicatively coupled, one to another. Although not shown, the computing device 802 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 804 is representative of functionality to perform one or more operations using hardware. Accordingly, the processing device 804 is illustrated as including hardware element 810 that is configurable as processors, functional blocks, and so forth. This includes implementation in hardware as an application specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 806 is illustrated as including memory/storage 812 that stores instructions that are executable to cause the processing device 804 to perform operations. The computer-readable storage medium is configured for storing instructions that, responsive to execution by the processing device, causes the processing device to perform operations. The memory/storage 812 represents memory/storage capacity associated with one or more computer-readable media. The memory/storage 812 includes volatile media (such as random access memory (RAM)) and/or nonvolatile media (such as read only memory (ROM), Flash memory, optical disks, magnetic disks, and so forth). The memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non- removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing device 804. The instructions and/or functions are executable/operable by one or more articles of manufacture (for example, one or more computing devices 802 and/or processing devices 804) to implement techniques, modules, and examples described herein.

The techniques described herein are supported by various configurations of the computing device 802 and are not limited to the specific examples of the techniques described herein. This functionality is also implementable all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that can be utilized while computer processing is executed on servers that are remote from the computing device 802. Resources 818 can also include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

In implementations, the platform 816 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
generating, by a processing device, a search result based on visual similarity of a plurality of digital images with respect to an input digital image, the generating including:
locating a plurality of candidate digital images from the plurality of digital images based on a search;
calculating spatial feature maps for the input digital image and the plurality of candidate digital images using respective layers of one or more neural networks; and
forming a plurality of similarity scores by comparing the spatial feature maps from the plurality of candidate digital images, respectively, with the spatial feature maps for the input digital image; and
outputting, by the processing device, the search result for display in a user interface, the search result indicating one or more of the candidate digital images having at least a threshold amount of visual similarity with respect to the input digital image based on the plurality of similarity scores.

2. The method as described in claim 1, wherein the similarity scores quantify an amount of visual similarity.

3. The method as described in claim 1, wherein the spatial feature maps are configured as layer activations from the respective layers of the one or more neural networks.

4. The method as described in claim 1, wherein the spatial feature maps are generated, respectively, by the respective layers of the one or more neural networks that are different, one to another.

5. The method as described in claim 1, wherein the locating is performed using visual descriptors as part of a nearest-neighbor search of feature vectors.

6. The method as described in claim 1, wherein the comparing includes comparing the spatial feature maps as describing a plurality of intermediate neural network activation levels of the one or more neural networks.

7. The method as described in claim 1, wherein the one or more neural networks are trained as binary classifiers.

8. The method as described in claim 1, wherein the forming of a respective said similarity score includes combining a result of a comparison of the spatial features maps of the input digital image with the spatial feature maps for a respective said candidate digital image.

9. The method as described in claim 8, wherein the forming the plurality of similarity scores is performed using a multilayer perceptron (MLP).

10. One or more computer-readable storage media storing instructions that, responsive to execution by a processing device, causes the processing device to perform operations comprising:
generating a plurality of feature vectors for a plurality of digital images using at least one machine-learning model;
forming a plurality of groups from the plurality of digital images based on a nearest neighbor search of the plurality of feature vectors;
determining visual similarity of the digital images included in a respective said group based on a plurality of intermediate neural network activation levels calculated for each of the digital images included in the respective said group using one or more neural networks; and
outputting a result of the determining.

11. The one or more computer-readable storage media as described in claim 10, wherein the determining includes calculating spatial feature maps for the plurality of digital images using respective layers of the one or more neural networks.

12. The one or more computer-readable storage media as described in claim 10, wherein the determining includes comparing the plurality of intermediate neural network activation levels from the digital images included in the respective said group.

13. The one or more computer-readable storage media as described in claim 10, wherein the determining includes forming a plurality of similarity scores using a multilayer perceptron (MLP) from the plurality of intermediate neural network activation levels.

14. The one or more computer-readable storage media as described in claim 10, wherein the one or more neural networks are trained as binary classifiers.

15. The one or more computer-readable storage media as described in claim 10, wherein the operations further comprise identifying duplicate digital images based on the result.

16. A computing device comprising:
a processing device; and
a computer-readable storage medium storing instructions that, responsive to execution by the processing device, causes the processing device to perform operations including:
comparing an input digital image at a plurality of intermediate neural network activation levels with a plurality of digital images, respectively; and
forming a plurality of similarity scores based on the comparing, the plurality of similarity scores quantifying an amount of visual similarity of the plurality of digital images with respect to the input digital image, respectively.

17. The computing device as described in claim 16, wherein the forming the plurality of similarity scores is performed using a multilayer perceptron (MLP) by combining a result of comparing the plurality of intermediate neural network activation levels from respective digital images of the plurality of digital images to each other.

18. The computing device as described in claim 16, wherein the plurality of intermediate neural network activation levels is generated using respective levels of a plurality of levels of one or more neural networks.

19. The computing device as described in claim 18, wherein the one or more neural networks are trained as binary classifiers.

20. The computing device as described in claim 16, wherein the operations further comprise grouping the digital images based on the plurality of similarity scores.
